(19) United States
(12) Patent Application Publication
(10) Pub. No.: US 2022/0377100 A1
(43) Pub. Date: Nov. 24, 2022

(54) Penetration Test Method and System for Network Device

(71) Applicant: East China Jiaotong University, Nanchang City (CN)

(72) Inventors: Meihua Xiao, Nanchang City (CN); Ri Ouyang, Nanchang City (CN); Zifan Song, Nanchang City (CN); Zhiliang Zhu, Nangchang City (CN)

(21) Appl. No.: 17/707,199

(22) Filed: Mar. 29, 2022

(30) Foreign Application Priority Data
May 19, 2021 (CN) 202110543219.6

(51) Int. Cl. H04L 9/40

(52) U.S. Cl. CPC H04L 63/1433; H04L 63/1416; H04L 63/1425; H04L 63/1466

(57) ABSTRACT

The present invention provides a penetration test method and system for a network device, and relates to the field of network device vulnerability analysis and prediction. The method includes: obtaining network device vulnerability data to construct a network device vulnerability knowledge base; mining the network device vulnerability data by using a preset association rule mining algorithm, to obtain a corresponding correlation rule; and performing a penetration test on a to-be-tested network device based on the network device vulnerability knowledge base and the association rule to generate a permeability packet, to predict unknown vulnerabilities. According to association rules between the devices, the vulnerabilities, and the devices and the vulnerabilities in the vulnerability knowledge base, permeability packets are selectively generated for the devices and the vulnerabilities, thereby greatly improving the test efficiency.

### CROSS REFERENCE TO RELATED APPLICATION

This patent application claims the benefit and priority of Chinese Patent Application No. 202110543219.6, filed on May 19, 2021, the disclosure of which is incorporated by reference herein in its entirety as part of the present application.

### TECHNICAL FIELD

The present invention relates to the field of network device vulnerability analysis and prediction, and in particular, to a penetration test method and system for a network device.

### BACKGROUND ART

Since there is no special network device classification in authoritative vulnerability databases such as a Chinese national vulnerability database (CNNVD), a national vulnerability database (NVD), and common vulnerabilities & exposures (CVE), it is difficult to obtain network device vulnerability data in practical applications. In addition, a permeability packet generated by performing a penetration test on a network device based on an existing vulnerability database usually features blindness and low efficiency.

### SUMMARY

In view of defects in the prior art, the technical problem to be resolved in the present invention is to provide a penetration test method and system for a network device.

The technical solution of the foregoing technical problem resolved in the present invention is as follows:

A penetration test method for a network device is provided, including:

obtaining network device vulnerability data to construct a network device vulnerability knowledge base;

mining the network device vulnerability data by using a preset association rule mining algorithm, to obtain a corresponding correlation rule; and

performing a penetration test on a to-be-tested network device based on the network device vulnerability knowledge base and the association rule to generate a permeability packet, to predict unknown vulnerabilities.

Beneficial effects of the present invention are as follows: In this solution, based on the network device vulnerability knowledge base of the network device vulnerability data, including an association rule between a plurality of network devices and the vulnerability, and according to these rules, a penetration test of vulnerability that may be in the network device may be effectively and purposefully performed, to analyze the security of the network device, and comprehensive network device vulnerability knowledge is formed by constructing the network device vulnerability knowledge base, to support the automatic generation of the penetration verification packet. Based on the constructed network device vulnerability knowledge base, automatic generation of the permeability packet is performed by matching target device information.

According to association rules between the devices, the vulnerabilities, and the devices and the vulnerabilities in the vulnerability knowledge base, permeability packets are selectively generated for the devices and the vulnerabilities, thereby greatly improving the test efficiency.

Further, before the mining the network device vulnerability data by using a preset association rule mining algorithm, the method further includes:

changing, according to a constructed network device vulnerability ontology, a vulnerability category attribute value in the network device vulnerability data being a third-level vulnerability category to a second-level vulnerability category, where vulnerability data of the second-level vulnerability category is at a high level, and vulnerability data of the third-level vulnerability category is at a low level.

The beneficial effects of adopting the foregoing further solution are as follows: In this solution, the vulnerability category attribute value of the network device vulnerability data is changed, so that the granularity of the network device vulnerability data is finer, and the vulnerability data at the low level is upgraded to the vulnerability data at the high level in the database, so that the support of itemsets in association rule mining is improved. Therefore, for the network device vulnerability ontology, an association rule between the vulnerabilities may be mined, to analyze and predict unknown vulnerabilities that are most likely to be in the target device, and to provide a basis for the subsequent generation of the penetration test packet to narrow a test scope.

Further, before the mining the network device vulnerability data by using a preset association rule mining algorithm, the method further includes:

constructing a vulnerability category and a hierarchical system of the network device vulnerability ontology according to a preset classification standard and with reference to a network device vulnerability feature;

constructing attributes of vulnerability of the network device vulnerability ontology based on network device defect types and network device defect properties; and

setting storage of the network device vulnerability ontology as a relational database storage, to complete construction of the network device vulnerability ontology.

The beneficial effects of adopting the foregoing further solution are as follows: The vulnerability database constructed in the solution in the prior art includes a large amount of data without granularity and levels. By using the existing mining algorithm, an information loss is caused during association analysis, which may cause that a potential association rule cannot be mined. In this solution, by constructing the network device vulnerability ontology, based on the network device vulnerability ontology, the vulnerability data at the low level is upgraded to the vulnerability data at the high level in the database, so that the support of itemsets in association rule mining is improved, to obtain more meaningful potential association rules.

Further, the method further includes obtaining the network device vulnerability data through a crawler tool and/or manual entry.

The beneficial effects of adopting the foregoing further solution are as follows: Because there is no specific network device classification in the existing vulnerability database, network device data cannot be directly obtained from a large amount of data, and the difficulty in obtaining the network device vulnerability data is relatively large. By developing the crawler tool and manual entry, the vulnerability data is obtained, to greatly expand the device vulnerability database, and to make the data in the vulnerability database as complete and rich as possible.

Further, the crawler tool includes a concurrent crawler tool in a master-slave mode of a master node and a slave node, the master node is configured to maintain a to-be-crawled queue of an entire crawler and a task assignment work, and the slave node is configured to accept tasks delegated by the master node;

each of the slave nodes maintains a task queue and a new link queue in real time, and after completing the task queue, the slave node merges the new link queue of the slave node into the to-be-crawled queue of the master node; and

the master node continues to delegate a link of the to-be-crawled queue to each slave node, and the slave node continues to crawl new network device vulnerability data.

The beneficial effects of adopting the foregoing further solution are as follows: Because there is no special network device classification in the existing vulnerability database, network device data cannot be directly obtained from a large amount of data, and the difficulty in obtaining the network device vulnerability data is relatively large. The vulnerability data is obtained through the crawler tool, to make the data in the vulnerability database more complete and richer. Due to a very large amount of vulnerability data, a requirement of quickly crawling a large amount of data can be met by using the concurrent crawler tool.

Another technical solution of the foregoing technical problem resolved in the present invention is as follows:

A penetration test system for a network device is provided, including: a knowledge base construction module, an association rule mining module, and a penetration test module.

The knowledge base construction module is configured to obtain network device vulnerability data to construct a network device vulnerability knowledge base;

the association rule mining module is configured to mine the network device vulnerability data by using a preset association rule mining algorithm, to obtain a corresponding correlation rule; and

the penetration test module is configured to perform a penetration test on a to-be-tested network device based on the network device vulnerability knowledge base and the association rule to generate a permeability packet, to predict unknown vulnerabilities.

Beneficial effects of the present invention are as follows: In this solution, based on the network device vulnerability knowledge base of the network device vulnerability data, including an association rule between a plurality of network devices and the vulnerability, and according to these rules, a penetration test of vulnerability that may be in the network device may be effectively and purposefully performed, to analyze the security of the network device, and comprehensive network device vulnerability knowledge is formed by constructing the network device vulnerability knowledge base, to support the automatic generation of the penetration verification packet. Based on the constructed network device vulnerability knowledge base, automatic generation of the permeability packet is performed by matching target device information.

According to association rules between the devices, the vulnerabilities, and the devices and the vulnerabilities in the vulnerability knowledge base, permeability packets are selectively generated for the devices and the vulnerabilities, thereby greatly improving the test efficiency.

Further, the system further includes the association support improvement module, configured to change, according to a constructed network device vulnerability ontology, a vulnerability category attribute value in the network device vulnerability data being a third-level vulnerability category to a second-level vulnerability category, where vulnerability data of the second-level vulnerability category is at a high level, and vulnerability data of the third-level vulnerability category is at a low level.

The beneficial effects of adopting the foregoing further solution are as follows: In this solution, the vulnerability category attribute value of the network device vulnerability data is changed, so that the granularity of the network device vulnerability data is finer, and the vulnerability data at the low level is upgraded to the vulnerability data at the high level in the database, so that the support of itemsets in association rule mining is improved. Therefore, for the network device vulnerability ontology, an association rule between the vulnerabilities may be mined, to analyze and predict unknown vulnerabilities that are most likely to be in the target device, and to provide a basis for the subsequent generation of the penetration test packet to narrow a test scope.

Further, the system further includes a vulnerability ontology construction module, configured to: construct a vulnerability category and a hierarchical system of the network device vulnerability ontology according to a preset classification standard and with reference to a network device vulnerability feature;

construct attributes of vulnerability of the network device vulnerability ontology based on network device defect types and network device defect properties; and

set storage of the network device vulnerability ontology as a relational database storage, to complete construction of the network device vulnerability ontology.

The beneficial effects of adopting the foregoing further solution are as follows: The vulnerability database constructed in the solution in the prior art includes a large amount of data without granularity and levels. By using the existing mining algorithm, an information loss is caused during association analysis, which may cause that a potential association rule cannot be mined. In this solution, by constructing the network device vulnerability ontology, based on the network device vulnerability ontology, the vulnerability data at the low level is upgraded to the vulnerability data at the high level in the database, so that the support of itemsets in association rule mining is improved, to obtain more meaningful potential association rules.

Further, the knowledge base construction module is further configured to obtain the network device vulnerability data through a crawler tool and/or manual entry.

The beneficial effects of adopting the foregoing further solution are as follows: Because there is no specific network device classification in the existing vulnerability database, network device data cannot be directly obtained from a large amount of data, and the difficulty in obtaining the network device vulnerability data is relatively large. By developing the crawler tool and manual entry, the vulnerability data is obtained, to greatly expand the device vulnerability database, and to make the data in the vulnerability database as complete and rich as possible.

Further, the crawler tool includes a concurrent crawler tool in a master-slave mode of a master node and a slave node, the master node is configured to maintain a to-be-crawled queue of an entire crawler and a task assignment work, and the slave node is configured to accept tasks delegated by the master node;

each of the slave nodes maintains a task queue and a new link queue in real time, and after completing the task queue, the slave node merges the new link queue of the slave node into the to-be-crawled queue of the master node; and

the master node continues to delegate a link of the to-be-crawled queue to each slave node, and the slave node continues to crawl new network device vulnerability data.

The beneficial effects of adopting the foregoing further solution are as follows: Because there is no special network device classification in the existing vulnerability database, network device data cannot be directly obtained from a large amount of data, and the difficulty in obtaining the network device vulnerability data is relatively large. The vulnerability data is obtained through the crawler tool, to make the data in the vulnerability database more complete and richer. Due to a very large amount of vulnerability data, a requirement of quickly crawling a large amount of data can be met by using the concurrent crawler tool.

Advantages of additional aspects of the present invention are partially given in the following description, and this part becomes apparent from the following description, or is learned by practice of the present invention.

### BRIEF DESCRIPTION OF THE DRAWINGS

FIG. 1 is a schematic flowchart of a penetration test method for a network device according to an embodiment of the present invention;

FIG. 2 is a structural framework diagram of a penetration test system for a network device according to an embodiment of the present invention;

FIG. 3 is a schematic diagram of a vulnerability category and a hierarchical system of a network device vulnerability ontology according to other embodiments of the present invention; and

FIG. 4 is a schematic diagram of a penetration test procedure according to other embodiments of the present invention.

### DETAILED DESCRIPTION OF THE EMBODIMENTS

The principle and features of the present invention are described below with reference to the accompanying drawings, and exemplary embodiments are merely used for explaining the present invention, but are not intended to limit the scope of the present invention.

FIG. 1 shows a penetration test method for a network device according to an embodiment of the present invention, which includes:

obtaining network device vulnerability data to construct a network device vulnerability knowledge base.

In an embodiment, because there is no special network device classification in authoritative vulnerability databases such as a CNNVD, an NVD, and CVE from which the vulnerability data may be obtained, network device data cannot be directly obtained from a large amount of data, and the difficulty in obtaining the network device vulnerability data is relatively large. For the foregoing problem, in the present invention, vulnerability data is obtained by developing a crawler tool and using manual entry, where a main manner is to use the automatic crawler tool, and an auxiliary manner is to use the manual entry. The crawler tool may be designed as follows:

When network device vulnerability data in the CNNVD and the NVD is crawled, each piece of vulnerability data has a unique ID corresponding to the vulnerability data. Therefore, the ID may be used as a basis for determining the uniqueness of the vulnerability data. In a process of accessing related vulnerability data, a vulnerability ID only needs to be used for accessing the related vulnerability data. The crawler tool designed in the present invention crawls the vulnerability data based on a breadth-first search policy.

During the whole crawling process, a crawler needs to maintain two search queues: a to-be-crawled queue and a crawled queue. In an initial state, the crawled queue is empty, and there is only one seed link in the to-be-crawled queue. A webpage to which the seed link is pointed is crawled, to obtain a vulnerability data link and a page link; the seed link then enters the crawled queue, and a link obtained through crawling enters the to-be-crawled queue; and links in the to-be-crawled queue are finally crawled one by one, and content to which the links are pointed is persistently stored. Each time one link is crawled, the link is moved to the crawled queue until the to-be-crawled queue is empty, and this process ends. Before a vulnerability data link obtained through crawling enters the to-be-crawled queue, whether the vulnerability data link is in the crawled queue is checked one by one according to a vulnerability ID. If not, the vulnerability data link enters the to-be-crawled queue. A crawling end condition is not only ended when the to-be-crawled queue is empty, but also is ended when a quantity of links in the to-be-crawled queue reaches a preset maximum value. The description of a crawler algorithm crawler is shown in an algorithm 1:

```
Algorithm 1: crawler
input: seedUrl #seed link
output: None
crawler (seedUrl):
  initialize Waiting WQueue
  initialize Finishing FQueue
  push seedUrl into WQueue
  while length (WQueue) < Max:
pop url from WQueue
push url into FQueue
get htmlDoc from url
parsing dataSet from htmlDoc
persist store dataset
get newUrl from dataset
if newUrl not in FQueue:
push newUrl into WQueue
```

Due to a very large amount of vulnerability data, it is difficult for a single-process crawler to meet a requirement of quickly crawling a large amount of data. Therefore, a concurrent crawler tool is designed in the present invention, to achieve the concurrent data crawling function and improve the data crawling efficiency. The concurrent crawler tool adopts a master-slave mode, that is, includes a master node and a slave node. The master node is configured to maintain a to-be-crawled queue of an entire crawler and a task assignment work, and the slave node is configured to accept tasks delegated by the master node, and perform data crawling according to a crawling rule of the algorithm 1. Each slave node needs to maintain two queues, where one is a task queue for storing a link assigned by the master node; and the other is a new link queue for storing a link obtained through crawling. After completing the task queue, the slave node merges the new link queue of the slave node into a to-be-crawled queue of the master node. In addition, the master node continues to delegate a link in the to-be-crawled queue to each slave node, and the slave node continues to crawl new data. The description of a concurrent crawler algorithm concurrent_crawler is shown in an algorithm 2:

```
  Algonthm 2: concurrent_crawler
  input: thread, N, M #thread, quantity of messages, quantity of
  concurrency
  ouput: None
  concurrent_crawler (thread,N,M):
      if thread is Master:
      initialize Waiting WQueue
      initialize Finishing FQueue
      load some urls from Disk into WQueue
    pop N*M urls from WQueue
        for i in range (0,M):
          send N urls to slaver (i)
    push N urls to FQueue
        while length (FQueue) < MaxNum:
    if receive newUrls from slaver (i):
for url in newUrls:
            if url not in WQueue:
    push url into WQueue
    pop N urls from WQueue
```

The manual entry is used for expanding the device vulnerability database. To make data in the vulnerability database as complete and rich as possible, it is necessary to retrieve the network device vulnerability data from authoritative databases such as a CNVD and CVE and a third-party vulnerability database, which is manually entered into the vulnerability database.

The network device vulnerability data is mined by using a preset association rule mining algorithm, to obtain a corresponding correlation rule. In an embodiment, the preset association rule mining algorithm may include an Apriori algorithm or other association rule mining algorithms, where the Apriori algorithm generates a candidate set based on an Apriori property, thereby greatly compressing the size of a frequent itemset and showing good performance.

A penetration test is performed on a to-be-tested network device based on the network device vulnerability knowledge base and the association rule to generate a permeability packet, to predict unknown vulnerabilities.

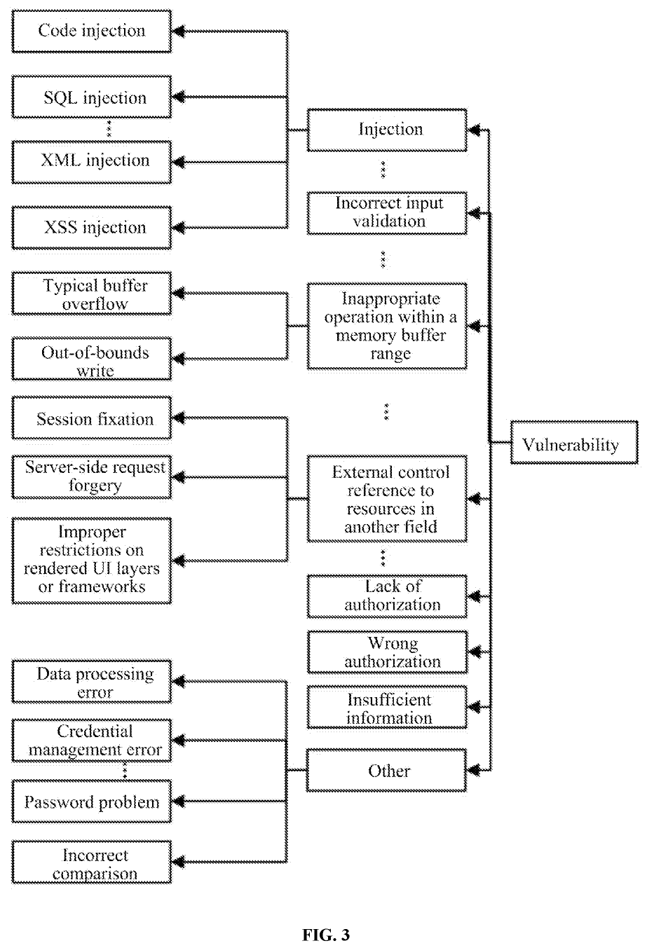

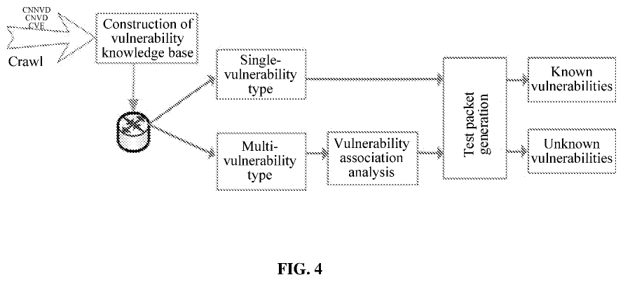

Preferably, in an embodiment, the constructed vulnerability database includes a large amount of data without granularity and levels. The Apriori algorithm obtains frequent itemsets through iteration and screens out itemsets that do not meet a minimum support. The foregoing two factors cause an information loss during association analysis, which may cause that a potential association rule cannot be mined. For example, a relationship between “injection” and “inappropriate operation within a memory buffer range” on a network device of a model is analyzed, and information such as “injection”, “typical buffer overflow”, and “out-of-bounds write” is obtained from the vulnerability database. As shown in FIG. 3, it may be learned that “injection” belongs to a second-level vulnerability category, and “typical buffer overflow” and “out-of-bounds write” belong to a third-level vulnerability category, which is a subcategory of the second-level vulnerability category “inappropriate operation within a memory buffer range”. In this case, due to the insufficient support of the vulnerability category, an association relationship between “injection” and “inappropriate operation within a memory buffer range” cannot be mined. With the support of the vulnerability ontology, a level of “typical buffer overflow” and “out-of-bounds write” is upgrade to that of “inappropriate operation within a memory buffer range”, which directly improves the support, and an association rule between “injection” and “inappropriate operation within a memory buffer range” may finally appear. This solution uses an association rule mining method based on the network device vulnerability ontology. By introducing semantic knowledge in a vulnerability domain, in a data preprocessing stage of data mining, based on the network device vulnerability ontology, the vulnerability data at the low level is upgraded to the vulnerability data at the high level in the database, so that the support of itemsets in association rule mining is improved, to obtain more meaningful potential association rules. A key to implementing this method is to change a vulnerability category attribute value of each piece of data of a second-level vulnerability category being a third-level vulnerability category to a corresponding second-level vulnerability category before the association rule is mined. To implement this operation, the constructed network device vulnerability ontology only needs to be used to complete a one-to-one mapping between a CWE number and a vulnerability category name, as shown in table 1, or to implement a many-to-one mapping between a three-level vulnerability category and a two-level vulnerability category, as shown in Table 2.

In this solution, based on the network device vulnerability knowledge base of the network device vulnerability data, including an association rule between a plurality of network devices and the vulnerability, and according to these rules, a penetration test of vulnerability that may be in the network device may be effectively and purposefully performed, to analyze the security of the network device, and comprehensive network device vulnerability knowledge is formed by constructing the network device vulnerability knowledge base, to support the automatic generation of the penetration verification packet. Based on the constructed network device vulnerability knowledge base, automatic generation of the permeability packet is performed by matching target device information.

According to association rules between the devices, the vulnerabilities, and the devices and the vulnerabilities in the vulnerability knowledge base, permeability packets are selectively generated for the devices and the vulnerabilities, thereby greatly improving the test efficiency.

Preferably, in the foregoing any embodiment, before the mining the network device vulnerability data by using a preset association rule mining algorithm, the method further includes:

changing, according to a constructed network device vulnerability ontology, a vulnerability category attribute value in the network device vulnerability data being a third-level vulnerability category to a second-level vulnerability category, where vulnerability data of the second-level vulnerability category is at a high level, and vulnerability data of the third-level vulnerability category is at a low level.

In this solution, the vulnerability category attribute value of the network device vulnerability data is changed, so that the granularity of the network device vulnerability data is finer, and the vulnerability data at the low level is upgraded to the vulnerability data at the high level in the database, so that the support of itemsets in association rule mining is improved. Therefore, for the network device vulnerability ontology, an association rule between the vulnerabilities may be mined, to analyze and predict unknown vulnerabilities that are most likely to be in the target device, and to provide a basis for the subsequent generation of the penetration test packet to narrow a test scope.

Preferably, in the foregoing any embodiment, before the mining the network device vulnerability data by using a preset association rule mining algorithm, the method further includes:

constructing a vulnerability category and a hierarchical system of the network device vulnerability ontology according to a preset classification standard and with reference to a network device vulnerability feature;

constructing attributes of vulnerability of the network device vulnerability ontology based on network device defect types and network device defect properties; and

setting storage of the network device vulnerability ontology as a relational database storage, to complete construction of the network device vulnerability ontology.

In an embodiment, the construction of the network device vulnerability ontology may include three parts: A vulnerability category and a hierarchical system are first defined, attributes of vulnerability are then defined, and storage of the vulnerability ontology is finally designed.

The vulnerability category and the hierarchical system defined in this solution of the present invention may be obtained based on a CWE (Common Weakness Enumeration) classification standard used by the NVD (US National vulnerability database) and the CVE and with reference to a network device vulnerability feature. A deeper-level vulnerability category indicates a finer granularity. The defined vulnerability category and the hierarchical system include a total of three levels. There are 24 types of vulnerability categories at a second level and 42 types at a third level. “Other” third-level vulnerability categories at the second level are not included in an original CWE classification standard. The categories are added in a manual manner by analyzing network device vulnerability features. For example, “data processing error” does not belong to any other vulnerability category. However, there is such vulnerability in the network device, and therefore, “data processing error” is classified into “another” category. The vulnerability category and the hierarchical system are shown in FIG. 3.

The attributes that define the vulnerability may include that: in the CWE, defect types and defect properties are different, and types and quantities of attributes are also different. In the present invention, 10 representative attributes are selected as the attributes of the vulnerability. The attributes of the vulnerability are shown in Table 1.

TABLE 1

| Field | Description |
|---|---|
| CWE ID | CWE number |
| Name | Vulnerability type name |
| Description | Description information |
| Relatiomliips | Parent and child node attachment |
| Applicable Phtfbnns | Applicable platform |
| Likelihood of Exploit | Possibility of being exploited |
| Conunon Consequences | Impact caused |
| Potential Mitigations | Measures for alleviating block defects in |
| Demons trath e Examples | Code exemplary example |
| Obsen ed Examples | Instances that have been discovered |

The storage of the vulnerability ontology may include that the network device vulnerability ontology is stored by using a relational database, and a vulnerability level relationship is associated by using the SuperCategory field and the SubCategory field in Table 2. The SuperCategory field stores a vulnerability parent category, and the SubCategory field stores a vulnerability subcategory. For example, if “injection” is used as the subcategory, the parent category is “vulnerability”. As shown in Table 2,

TABLE 2

| SubCategory | SuperCategory |
|---|---|
| Injection | Vulnerability |
| Incorrect input validation | Vulnerability |
| Inappropriate operation in a memory range | Vulnerability |
| Insufficient information | Vulnerability |
| Other | Vulnerability |
| Code injection | Injection |
| SQL injection | Injection |
| XML injection | Injection |
| XSS injection | Injection |
| Data processing error | Other |
| Credential management error | Other |
| Password problem | Other |
| Incorrect comparison | Other |

The vulnerability database constructed in the solution in the prior art includes a large amount of data without granularity and levels. By using the existing mining algorithm, an information loss is caused during association analysis, which may cause that a potential association rule cannot be mined. In this solution, by constructing the network device vulnerability ontology, based on the network device vulnerability ontology, the vulnerability data at the low level is upgraded to the vulnerability data at the high level in the database, so that the support of itemsets in association rule mining is improved, to obtain more meaningful potential association rules.

Preferably, in the foregoing any embodiment, the method further includes obtaining the network device vulnerability data through a crawler tool and/or manual entry.

Because there is no specific network device classification in the existing vulnerability database, network device data cannot be directly obtained from a large amount of data, and the difficulty in obtaining the network device vulnerability data is relatively large. By developing the crawler tool and manual entry, the vulnerability data is obtained, to greatly expand the device vulnerability database, and to make the data in the vulnerability database as complete and rich as possible.

Preferably, in the foregoing any embodiment, the crawler tool includes a concurrent crawler tool in a master-slave mode of a master node and a slave node, the master node is configured to maintain a to-be-crawled queue of an entire crawler and a task assignment work, and the slave node is configured to accept tasks delegated by the master node;

each of the slave nodes maintains a task queue and a new link queue in real time, and after completing the task queue, the slave node merges the new link queue of the slave node into the to-be-crawled queue of the master node; and

the master node continues to delegate a link of the to-be-crawled queue to each slave node, and the slave node continues to crawl new network device vulnerability data.

Because there is no special network device classification in the existing vulnerability database, network device data cannot be directly obtained from a large amount of data, and the difficulty in obtaining the network device vulnerability data is relatively large. The vulnerability data is obtained through the crawler tool, to make the data in the vulnerability database more complete and richer. Due to a very large amount of vulnerability data, a requirement of quickly crawling a large amount of data can be met by using the concurrent crawler tool.

In an embodiment, as shown in FIG. 4, network device data is obtained from a large amount of data in the databases CNNVD, the CNVD, and the CVE through the crawler tool, to determine whether the network device data is of a single-vulnerability type or a multi-vulnerability type. If the network device data is of the multi-vulnerability type for vulnerability association analysis, a packet is automatically tested. For the network device vulnerability ontology, an association rule between the vulnerabilities may be mined, to analyze and predict unknown vulnerabilities that are most likely to be in the target device, and to provide a basis for the subsequent generation of the penetration test packet to narrow a test scope.

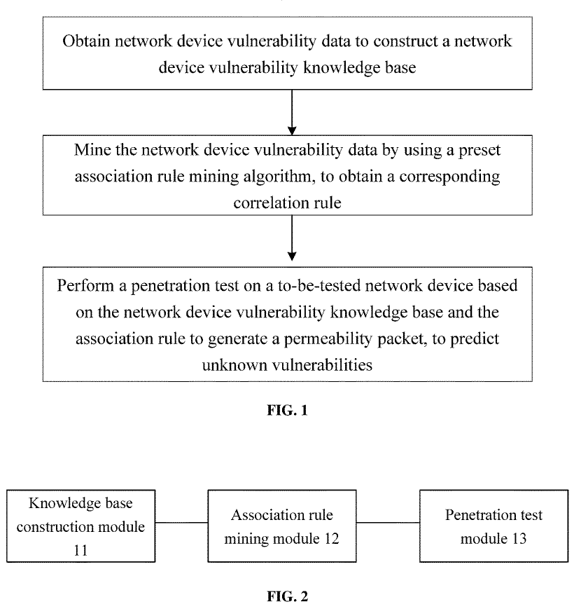

In an embodiment, as shown in FIG. 2, a penetration test system for a network device is provided, including: a knowledge base construction module 11, an association rule mining module 12, and a penetration test module 13.

The knowledge base construction module 11 is configured to obtain network device vulnerability data to construct a network device vulnerability knowledge base;

the association rule mining module 12 is configured to mine the network device vulnerability data by using a preset association rule mining algorithm, to obtain a corresponding correlation rule;

the penetration test module 13 is configured to perform a penetration test on a to-be-tested network device based on the network device vulnerability knowledge base and the association rule to generate a permeability packet, to predict unknown vulnerabilities.

In this solution, based on the network device vulnerability knowledge base of the network device vulnerability data, including an association rule between a plurality of network devices and the vulnerability, and according to these rules, a penetration test of vulnerability that may be in the network device may be effectively and purposefully performed, to analyze the security of the network device, and comprehensive network device vulnerability knowledge is formed by constructing the network device vulnerability knowledge base, to support the automatic generation of the penetration verification packet. Based on the constructed network device vulnerability knowledge base, automatic generation of the permeability packet is performed by matching target device information.

According to association rules between the devices, the vulnerabilities, and the devices and the vulnerabilities in the vulnerability knowledge base, permeability packets are selectively generated for the devices and the vulnerabilities, thereby greatly improving the test efficiency.

Preferably, in the foregoing any embodiment, the system further includes the association support improvement module, configured to change, according to a constructed network device vulnerability ontology, a vulnerability category attribute value in the network device vulnerability data being a third-level vulnerability category to a second-level vulnerability category, where vulnerability data of the second-level vulnerability category is at a high level, and vulnerability data of the third-level vulnerability category is at a low level.

In this solution, the vulnerability category attribute value of the network device vulnerability data is changed, so that the granularity of the network device vulnerability data is finer, and the vulnerability data at the low level is upgraded to the vulnerability data at the high level in the database, so that the support of itemsets in association rule mining is improved. Therefore, for the network device vulnerability ontology, an association rule between the vulnerabilities may be mined, to analyze and predict unknown vulnerabilities that are most likely to be in the target device, and to provide a basis for the subsequent generation of the penetration test packet to narrow a test scope.

Preferably, in the foregoing any embodiment, the system further includes a vulnerability body construction module, configured to: construct a vulnerability category and a hierarchical system of the network device vulnerability body according to a preset classification standard and with reference to a network device vulnerability feature;

construct attributes of vulnerability of the network device vulnerability ontology based on network device defect types and network device defect properties; and

set storage of the network device vulnerability ontology as a relational database storage, to complete construction of the network device vulnerability ontology.

The vulnerability database constructed in the solution in the prior art includes a large amount of data without granularity and levels. By using the existing mining algorithm, an information loss is caused during association analysis, which may cause that a potential association rule cannot be mined. In this solution, by constructing the network device vulnerability ontology, based on the network device vulnerability ontology, the vulnerability data at the low level is upgraded to the vulnerability data at the high level in the database, so that the support of itemsets in association rule mining is improved, to obtain more meaningful potential association rules.

Preferably, in the foregoing any embodiment, the knowledge base construction module 11 is further configured to obtain the network device vulnerability data through a crawler tool and/or manual entry.

Because there is no specific network device classification in the existing vulnerability database, network device data cannot be directly obtained from a large amount of data, and the difficulty in obtaining the network device vulnerability data is relatively large. By developing the crawler tool and manual entry, the vulnerability data is obtained, to greatly expand the device vulnerability database, and to make the data in the vulnerability database as complete and rich as possible.

Preferably, in the foregoing any embodiment, the crawler tool includes a concurrent crawler tool in a master-slave mode of a master node and a slave node, the master node is configured to maintain a to-be-crawled queue of an entire crawler and a task assignment work, and the slave node is configured to accept tasks delegated by the master node;

each of the slave nodes maintains a task queue and a new link queue in real time, and after completing the task queue, the slave node merges the new link queue of the slave node into the to-be-crawled queue of the master node; and

the master node continues to delegate a link of the to-be-crawled queue to each slave node, and the slave node continues to crawl new network device vulnerability data.

Because there is no special network device classification in the existing vulnerability database, network device data cannot be directly obtained from a large amount of data, and the difficulty in obtaining the network device vulnerability data is relatively large. The vulnerability data is obtained through the crawler tool, to make the data in the vulnerability database more complete and richer. Due to a very large amount of vulnerability data, a requirement of quickly crawling a large amount of data can be met by using the concurrent crawler tool.

It may be understood that in some embodiments, some or all of the optional implementations in the foregoing embodiments may be included.

It should be noted that the foregoing embodiments are product embodiments corresponding to foregoing method embodiments. For the description of optional implementations in the product embodiments, refer to the corresponding description in the foregoing method embodiments, and details are not described herein again.

Readers should understand that in the description of this specification, the description of the reference terms “one embodiment”, “some embodiments”, “example”, “specific example” or “some examples” means that the specific features, structures, materials or features described with reference to the embodiment or example are included in at least one embodiment or example of the present invention. In this specification, the illustrative expressions of the foregoing terms are not intended to refer to the same embodiment or example. In addition, the described specific features, structures, materials or features may be combined in any appropriate manner in any one or more embodiments or examples. In addition, a person skilled in the art may integrate and combine the different embodiments or examples described in this specification with the features of different embodiments or examples without conflicting each other.

In several embodiments provided in this application, it may be understood that the disclosed system and method may be implemented in other manners. For example, the described system embodiment is merely an example. For example, the unit division is merely logical function division and may be other division in actual implementation. For example, multiple units or components may be combined or integrated into another system, or some features may be ignored or not performed.

The units described as separate parts may or may not be physically separate, and parts displayed as units may or may not be physical units, that is, may be located in one location, or may be distributed on a plurality of network units. Some or all of the units may be selected based on actual requirements to achieve the objectives of the solutions in the embodiments of the present invention.

In addition, functional units in each embodiment of the present invention may be integrated into one processing unit, or each unit may have separate physical existence, or two or more units may be integrated in one unit. The integrated units can be implemented in the form of hardware or software function units.

When the integrated units are implemented in the form of a software functional unit and sold or used as an independent product, the integrated units may be stored in a computer readable storage medium. Based on such an understanding, the essence of the technical solutions of the present invention, or the part contributing to the prior art, or all or some of the technical solutions may be represented in the form of software products. The computer software products are stored in a storage medium, and include several instructions to enable a computer device (which may be a personal computer, a server, a network device, or the like) to perform all or some of the steps in the methods of the embodiments of the present invention. The foregoing storage medium includes various mediums that may store program code, such as a USB flash drive, a mobile hard disk, a read-only memory (ROM), a random access memory (RAM), a magnetic disk, or an optical disk.

The foregoing descriptions are merely specific implementations of the present invention, but are not intended to limit the protection scope of the present invention. Various equivalent modifications or replacements readily figured out by a person skilled in the art within the technical scope disclosed in the present invention shall fall within the protection scope of the present invention. Therefore, the protection scope of the present invention shall be subject to the protection scope of the claims.

What is claimed is:

1. A penetration test method for a network device, comprising:
obtaining network device vulnerability data to construct a network device vulnerability knowledge base;
mining the network device vulnerability data by using a preset association rule mining algorithm, to obtain a corresponding correlation rule; and
performing a penetration test on a to-be-tested network device based on the network device vulnerability knowledge base and the association rule to generate a permeability packet, to predict unknown vulnerabilities,
wherein before the mining the network device vulnerability data by using a preset association rule mining algorithm, the method further comprises:
changing, according to a constructed network device vulnerability ontology, a vulnerability category attribute value in the network device vulnerability data being a third-level vulnerability category to a second-level vulnerability category, wherein vulnerability data of the second-level vulnerability category is at a high level, and vulnerability data of the third-level vulnerability category is at a low level.

2. The penetration test method for a network device according to claim 1, wherein before the mining the network device vulnerability data by using a preset association rule mining algorithm, the method further comprises:
constructing a vulnerability category and a hierarchical system of the network device vulnerability ontology according to a preset classification standard and with reference to a network device vulnerability feature;
constructing attributes of vulnerability of the network device vulnerability ontology based on network device defect types and network device defect properties; and
setting storage of the network device vulnerability ontology as a relational database storage, to complete construction of the network device vulnerability ontology.

3. The penetration test method for a network device according to claim 1, further comprising obtaining the network device vulnerability data through a crawler tool and/or manual entry.

4. The penetration test method for a network device according to claim 3, wherein the crawler tool comprises a concurrent crawler tool in a master-slave mode of a master node and a slave node, the master node is configured to maintain a to-be-crawled queue of an entire crawler and a task assignment work, and the slave node is configured to accept tasks delegated by the master node;
each of the slave nodes maintains a task queue and a new link queue in real time, and after completing the task queue, the slave node merges the new link queue of the slave node into the to-be-crawled queue of the master node; and
the master node continues to delegate a link of the to-be-crawled queue to each slave node, and the slave node continues to crawl new network device vulnerability data.

5. A penetration test system for a network device, comprising: an association support improvement module, a knowledge base construction module, an association rule mining module, and a penetration test module, wherein
the knowledge base construction module is configured to obtain network device vulnerability data to construct a network device vulnerability knowledge base;
the association rule mining module is configured to mine the network device vulnerability data by using a preset association rule mining algorithm, to obtain a corresponding correlation rule;
the penetration test module is configured to perform a penetration test on a to-be-tested network device based on the network device vulnerability knowledge base and the association rule to generate a permeability packet, to predict unknown vulnerabilities; and
the association support improvement module is configured to change, according to a constructed network device vulnerability ontology, a vulnerability category attribute value in the network device vulnerability data being a third-level vulnerability category to a second-level vulnerability category, wherein vulnerability data of the second-level vulnerability category is at a high level, and vulnerability data of the third-level vulnerability category is at a low level.

6. The penetration test system for a network device according to claim 5, further comprising: a vulnerability ontology construction module, configured to: construct a vulnerability category and a hierarchical system of the network device vulnerability ontology according to a preset classification standard and with reference to a network device vulnerability feature;
constructing attributes of vulnerability of the network device vulnerability ontology based on network device defect types and network device defect properties; and
setting storage of the network device vulnerability ontology as a relational database storage, to complete construction of the network device vulnerability ontology.

7. The penetration test system for a network device according to claim 5, wherein the knowledge base construction module is further configured to obtain the network device vulnerability data through a crawler tool and/or manual entry.

8. The penetration test system for a network device according to claim 7, wherein the crawler tool comprises a concurrent crawler tool in a master-slave mode of a master node and a slave node, the master node is configured to maintain a to-be-crawled queue of an entire crawler and a task assignment work, and the slave node is configured to accept tasks delegated by the master node;
each of the slave nodes maintains a task queue and a new link queue in real time, and after completing the task queue, the slave node merges the new link queue of the slave node into the to-be-crawled queue of the master node; and
the master node continues to delegate a link of the to-be-crawled queue to each slave node, and the slave node continues to crawl new network device vulnerability data.
